(19) United States
(12) Patent Application Publication
(10) Pub. No.: US 2003/0086002 A1
(43) Pub. Date: May 8, 2003

(54) Method and system for compositing images

(75) Inventors: Nathan D. Cahill, West Henrietta, NY (US); Edward B. Gindele, Rochester, NY (US); Andrew C. Gallagher, Brockport, NY (US); Kevin E. Spaulding, Spencerport, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/008,026

(22) Filed: Nov. 5, 2001

(51) Int. Cl. H04N 5/225

(52) U.S. Cl. 348/218.1

(57) ABSTRACT

A method for producing a composite digital image, includes the steps of: providing a plurality of partially overlapping source digital images having pixel values that are linearly or logarithmically related to scene intensity; modifying the source digital images by applying linear exposure transforms to one or more of the source digital images to produce adjusted source digital images having pixel values that closely match in an overlapping region; and combining the adjusted source digital images to form a composite digital image.

### FIELD OF THE INVENTION

The invention relates generally to the field of digital image processing, and in particular to a technique for compositing multiple images into a panoramic image comprising a large field of view of a scene.

### BACKGROUND OF THE INVENTION

Conventional methods of generating panoramic images comprising a wide field of view of a scene from a plurality of images generally have the following steps: (1) an image capture step, where the plurality of images of a scene are captured with overlapping pixel regions; (2) an image warping step, where the captured images are geometrically warped onto a cylinder, sphere, or any geometric surface suitable for viewing or display; (3) an image registration step, where the warped images are aligned; and (4) a blending step, where the aligned warped images are blended together to form the panoramic image.

In the image capture step, the camera position may be constrained to simplify subsequent steps in the generation of the panoramic image. For example, in U.S. Ser. No. 09/224,547, filed Dec. 31, 1998 by Parulski et al., overlapping images are captured by a digital camera that rotates on a tripod. Alternatively, a “stitch assist” mode (as in the Canon PowerShot series of digital cameras; see http://www.powershot.com/powershot2/a20_a10/press.html); U.S. Pat. No. 6,243,103 issued Jun. 5, 2001 to Takiguchi et al.; and U.S. Pat. No. 5,138,460 issued Aug. 11, 1992 to Egawa may be employed to assist the user in capturing images with appropriate overlapping regions. Currently, all of these systems require that the exposure be locked after the first image is captured, so as to ensure that the overall brightness, contrast, and gamma remain the same in subsequent images. Ensuring that these parameters do not change across the sequence of images simplifies the image registration and image blending steps.

One problem with locking the exposure after the first image is captured is that subsequent images may be underexposed or overexposed. This would happen frequently with outdoor scenes, where the direction of sunlight is drastically different as the camera is moved. A desired system is one where the exposure is not locked for all images in the plurality of images; rather, each image in the plurality of images can be captured with its own distinct exposure characteristics.

Teo describes such a desired system in U.S. Pat. No. 6,128,108 issued Oct. 3, 2000. In Teo's system of combining two overlapping images, the code values of one or both images are adjusted by a nonlinear optimization procedure so that the overall brightness, contrast and gamma factors of both images are similar. He teaches that the pixels in the overlap region of the first image I are related to the pixels in the overlap region of the second image I′ by the formula I′=α+β·I^{γ}, where α, β, and γ are the brightness, contrast, and gamma factors, respectively. The α, β, and γ parameters are estimated directly from the pixel values in the overlap region, and then applied to the first image in order to make the pixel values in the overlap region of each image similar. The problem with Teo's system is that, since the α, β, and γ parameters are estimated directly from the pixel values in the overlap region, those parameters depend solely on the content of the scene. Furthermore, changing the brightness, contrast, and/or gamma factors of an image that has already been optimally rendered into a form suitable for hardcopy output or softcopy display will alter the rendered image, causing the corresponding characteristics of the output to be suboptimal. For example, many current digital cameras produce images with pixel values in the sRGB color space (see Stokes, Anderson, Chandrasekar and Motta, “A Standard Default Color Space for the Internet—sRGB”, http://www.color.org/sRGB.html). Images in sRGB have already been optimally rendered for video display, typically by applying a 3×3 color transformation matrix and then a gamma compensation lookup table. Any adjustment to the brightness, contrast, and gamma characteristics of an sRGB image will degrade the optimal rendering.

There is a need therefore for an improved method of panoramic image generation that will combine images into a composite image; the method being capable of combining images exposed under different exposure characteristics into a composite image that does not alter any characteristics of the original images that would otherwise yield a suboptimal rendered output image.

### SUMMARY OF THE INVENTION

The need is met according to the present invention by providing a method for producing a composite digital image that includes the steps of: providing a plurality of partially overlapping source digital images having pixel values that are linearly or logarithmically related to scene intensity; modifying the source digital images by applying linear exposure transforms to one or more of the source digital images to produce adjusted source digital images having pixel values that closely match in an overlapping region; and combining the adjusted source digital images to form a composite digital image.

In a digital image containing pixel values representative of a linear or logarithmic space with respect to the original scene exposures, the pixel values can be adjusted without degrading any subsequent rendering steps. Therefore, the linear exposure transformations according to the present invention are independent of the content of the scene (but rather dependent on the pedigree of the image), and do not degrade the characteristics to which an image has been rendered.

### Advantages

The present invention has the advantage of simply and efficiently matching source digital images having different initial exposures such that the exposures are equalized while minimizing any changes in contrast prior to the compositing step. The compositing of the digital images is also simplified even when one or more of the digital images have been previously rendered.

### BRIEF DESCRIPTION OF THE DRAWINGS

FIG. 1 is a block diagram illustrating a digital image processing system suitable for practicing the present invention;

FIG. 2 is a block diagram showing the method of forming a composite digital image from at least two source digital images according to the present invention;

FIGS. 3A and 3B are diagrams illustrating the overlap regions between source digital images;

FIG. 4 is a block diagram showing the step of providing source digital images;

FIG. 5 is a block diagram showing the step of modifying a source digital image;

FIG. 6 is a graph showing a transformation between the two images that is represented by a constant offset;

FIG. 7 is a graph showing a transformation between the two images that is represented by a linear transformation;

FIG. 8 is a diagram useful in describing the step of combining the adjusted source digital images;

FIG. 9 is a block diagram showing the method of forming a composite digital image from at least two source digital images and transforming its pixel values into an output device compatible color space according to an alternative embodiment of the present invention; and,

FIGS. 10A and 10B are diagrams illustrating a source digital image file containing image data and meta-data.

### DETAILED DESCRIPTION OF THE INVENTION

The present invention will be described as implemented in a programmed digital computer. It will be understood that a person of ordinary skill in the art of digital image processing and software programming will be able to program a computer to practice the invention from the description given below. The present invention may be embodied in a computer program product having a computer readable storage medium such as a magnetic or optical storage medium bearing machine readable computer code. Alternatively, it will be understood that the present invention may be implemented in hardware or firmware.

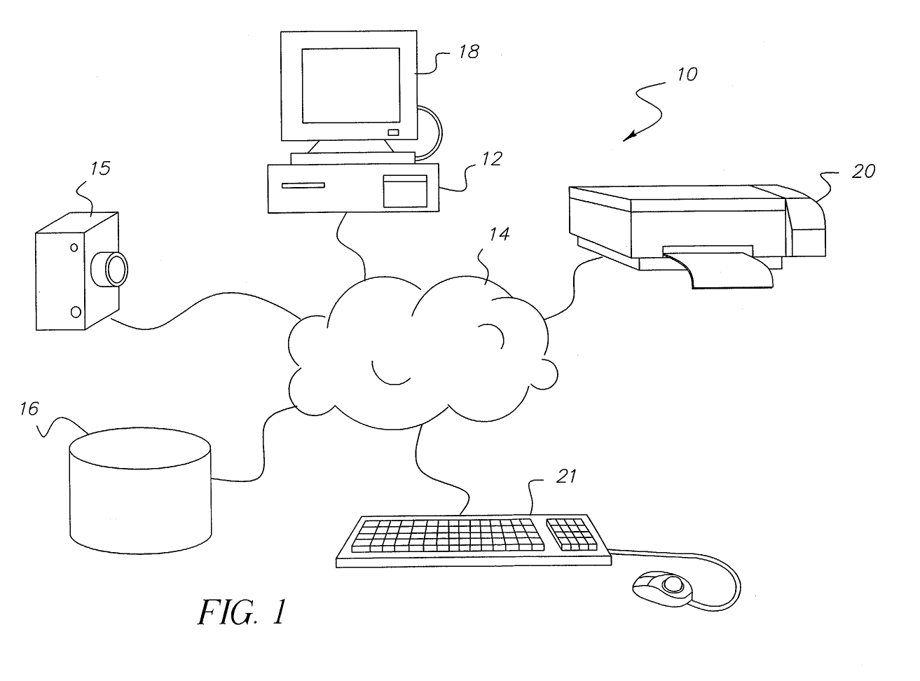

Referring first to FIG. 1, a digital image processing system useful for practicing the present invention is shown. The system generally designated 10, includes a digital image processing computer 12 connected to a network 14. The digital image processing computer 12 can be, for example, a Sun Sparcstation, and the network 14 can be, for example, a local area network with sufficient capacity to handle large digital images. The system includes an image capture device 15, such as a high resolution digital camera, or a conventional film camera and a film digitizer, for supplying digital images to network 14. A digital image store 16, such as a magnetic or optical multi-disk memory, connected to network 14 is provided for storing the digital images to be processed by computer 12 according to the present invention. The system 10 also includes one or more display devices, such as a high resolution color monitor 18, or hard copy output printer 20 such as a thermal or inkjet printer. An operator input, such as a keyboard and track ball 21, may be provided on the system.

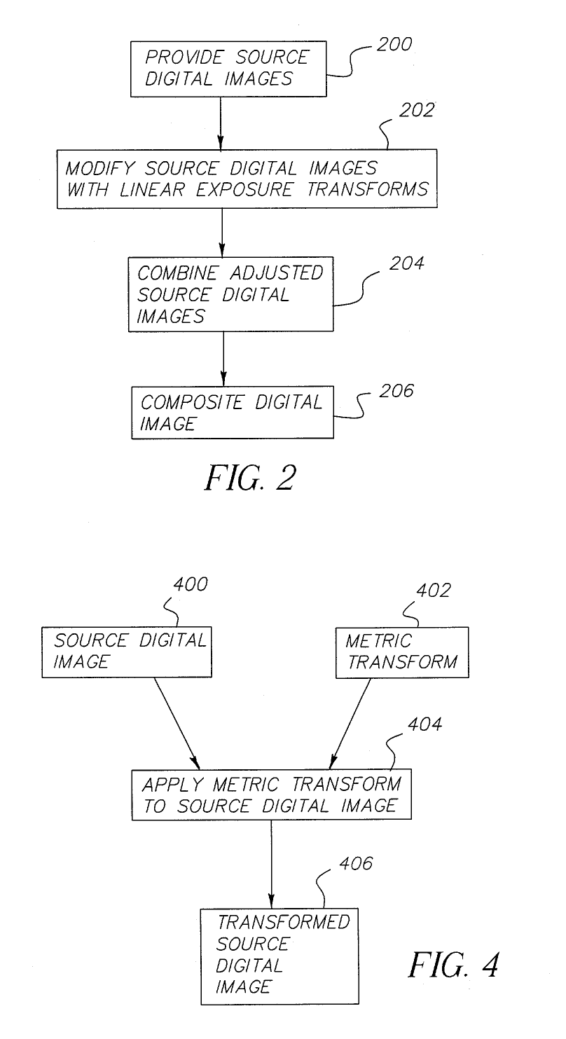

Referring next to FIG. 2, at least two overlapping source digital images are provided 200 to the processing system 10. The source digital images can be provided by a variety of means; for example, they can be captured from a digital camera, extracted from frames of a video sequence, scanned from hardcopy output, or generated by any other means. The pixel values of at least one of the source digital images are modified 202 by a linear exposure transform so that the pixel values in the overlap regions of overlapping source digital images are similar, yielding a set of adjusted source digital images. A linear exposure transform refers to a transformation that is applied to the pixel values of a source digital image, the transformation being linear with respect to the scene intensity values at each pixel. The adjusted source digital images are then combined 204 by a feathering scheme, weighted averages, or some other blending technique known in the art, to form a composite digital image 206.

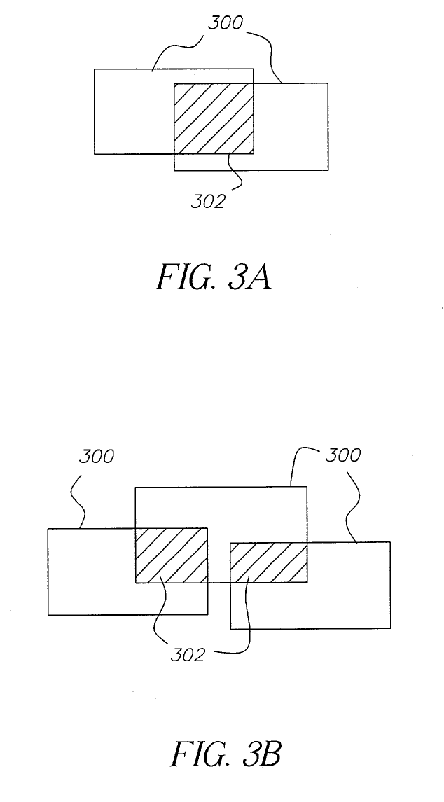

Referring next to FIGS. 3A and 3B, the at least two source digital images 300 overlap in overlapping pixel regions 302.

Referring next to FIG. 4, the step 200 of providing at least two source digital images further comprises the step 404 of applying a metric transform 402 to a source digital image 400 to yield a transformed source digital image 406. A metric transform refers to a transformation that is applied to the pixel values of a source digital image, the transformation yielding transformed pixel values that are linearly or logarithmically related to scene intensity values. In instances where metric transforms are independent of the particular content of the scene, they are referred to as scene independent transforms.

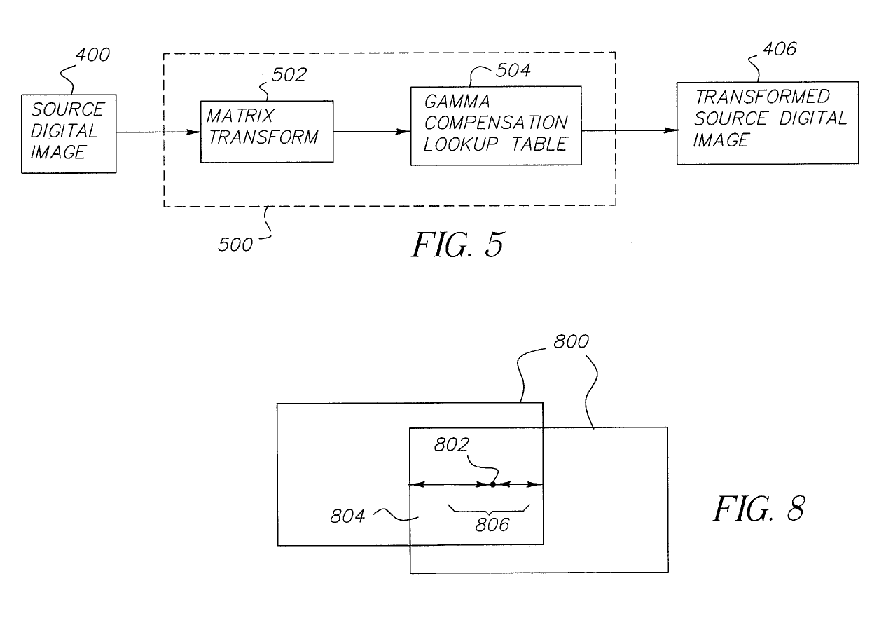

Referring next to FIG. 5, in one embodiment, the metric transform 500 includes a matrix transformation 502 and a gamma compensation lookup table 504. In one example of such an embodiment, a source digital image 400 was provided from a digital camera, and contains pixel values in the sRGB color space. A metric transform 500 is used to convert the pixel values into nonlinearly encoded Extended Reference Input Medium Metric (ERIMM) (PIMA standard #7466, found on the World Wide Web at http://www.pima.net/standards/it10/IT10_POW.htm), so that the pixel values are logarithmically related to scene intensity values.

The metric transform is applied to rendered digital images, i.e. digital images that have been processed to produce a pleasing result when viewed on an output device such as a CRT monitor or a reflection print. For digital images encoded in the sRGB metric the gamma compensation lookup table 504 is applied to the source digital image 400 first. The formula for the gamma compensation lookup table 504 is as follows. For each code value cv, ranging from 0 to 255, an exposure value ev is calculated based on the logic:

if (cv<=10.015) ev=cv/(255*12.92)

otherwise

ev=(cv/255)+0.055)/1.055)^{0.45}

Once the pixel values are modified with the gamma compensation lookup table, a color matrix transform is applied to compensate for the differences between the sRGB color primaries and the ERIMM metric color primaries. The nine elements of the color matrix τ are given by:

| | | |
|---|---|---|
| 0.5229 | 0.3467 | 0.1301 |
| 0.0892 | 0.8627 | 0.0482 |
| 0.0177 | 0.1094 | 0.8727 |

The color matrix is applied to the red, green, blue pixel data as

R′=τ₁₁R+τ₁₂G+τ₁₃B

G′=τ₂₁R+τ₂₂G+τ₂₃B

B′=τ₃₁R+τ₃G+τ₃₃B

where the R, G, B terms represent the red, green, blue pixel values to be processed by the color matrix and the R′, G′, B′ terms represent the transformed red, green, blue pixel values. The R′, G′, and B′ pixel values are then converted to a log domain representation thus completing the metric transformation from sRGB to ERIMM.

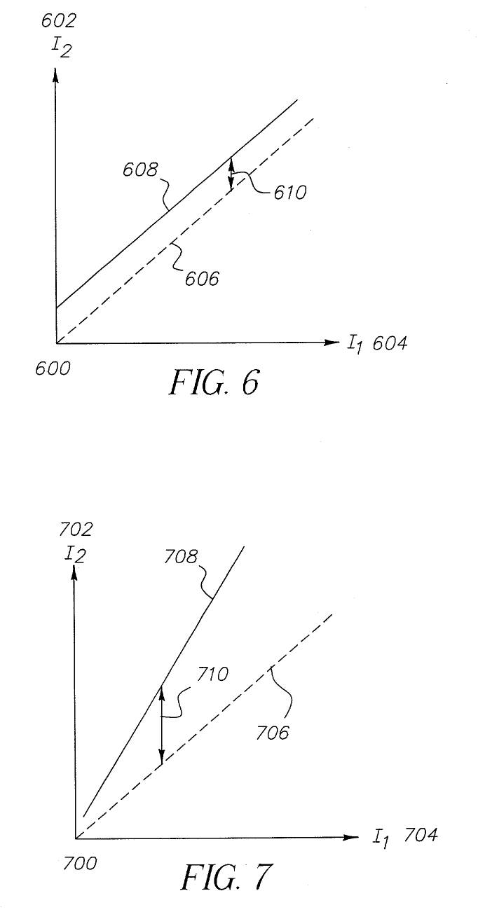

Referring next to FIG. 6, we show a plot 600 of the pixel values in the overlap region of the second source digital 602 versus the pixel values of the overlap region of the first source digital image 604. If the pixel values in the overlap regions are identical, the resulting plot would yield the identity line 606. In the case that the difference between the pixel values of the two images is a constant, the resulting plot would yield the line 608, which differs at each value by a constant amount 610. The step 202 of modifying at least one of the source digital images by a linear exposure transform would then comprise applying the constant amount 610 to each pixel in the first source digital image. One example of when a linear exposure transform would be constant is when the pixel values of the source digital images are in the nonlinearly encoded Extended Reference Input Medium Metric. The constant coefficient of the linear exposure transform can be estimated by a linear least squares technique (see “Solving Least Squares Problems”, C. L. Lawson and R. J. Hanson, SIAM, 1995) that minimizes the error between the pixel values in the overlap region of the second source digital image and the transformed pixel values in the overlap region of the first source digital image.

In another embodiment, the linear exposure transforms are not estimated, but rather computed directly from the shutter speed and F-number of the lens aperture. If the shutter speed and F-number of the lens aperture are known (for example, if they are stored in meta-data associated with the source digital image at the time of capture), they can be used to estimate the constant offset between source digital images whose pixel values are related to the original log exposure values. If the shutter speed (in seconds) and F-number of the lens aperture for the first image are T₁ and F₁, respectively, and the shutter speed (in seconds) and F-number of the lens aperture for the second image are T₂ and F₂, respectively, then the constant offset between the log exposure values is given by:

log₂(F₂²)+log₂(T₂)−log₂(F₁²)−log₂(T₁),

and this constant offset can be added to the pixel values in the first source digital image.

Referring next to FIG. 7, we show a plot 700 of the pixel values in the overlap region of the second source digital 702 versus the pixel values of the overlap region of the first source digital image 704. If the pixel values in the overlap regions are identical, the resulting plot would yield the identity line 706. In the case that the difference between the two images is a linear transformation, the resulting plot would yield the line 708, which differs at each value by an amount 710 that varies linearly with the pixel value of the first source digital image. The step 202 of modifying at least one of the source digital images by a linear exposure transform would then comprise applying the varying amount 710 to each pixel in the first source digital image. One example of when a linear exposure transform would contain a nontrivial linear term is when the pixel values of the source digital images are in the Extended Reference Input Medium Metric. The linear and constant coefficients of the linear exposure transform can be estimated by a linear least squares technique as described above with reference to FIG. 6.

Referring next to FIG. 8, the adjusted source digital images 800 are combined 204 by a feathering scheme, weighted averages, or some other blending technique known in the art, to form a composite digital image 206. In one embodiment, a pixel 802 in the overlap region 804 is assigned a value based on a weighted average of the pixel values from both adjusted source digital images 800; the weights are based on its relative distances 806 to the edges of the adjusted source digital images 800.

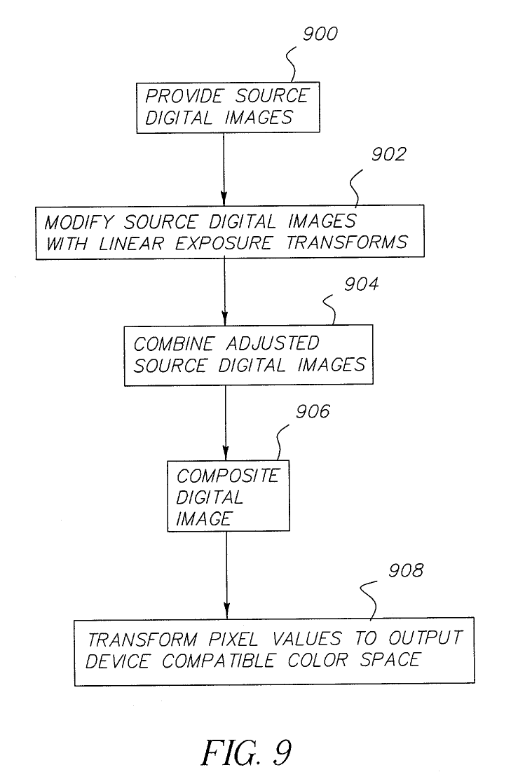

Referring next to FIG. 9, at least two source digital images are provided 900 to the processing system 10. The pixel values of at least one of the source digital images are modified 902 by a linear exposure transform so that the pixel values in the overlap regions of overlapping source digital images are similar, yielding a set of adjusted source digital images. The adjusted source digital images are then combined 904 by a feathering scheme, weighted averages, or some other blending technique known in the art, to form a composite digital image 906. The pixel values of the composite digital image are then converted into an output device compatible color space 908. The output device compatible color space can be chosen for any of a variety of output scenarios; for example, video display, photographic print, ink-jet print, or any other output device.

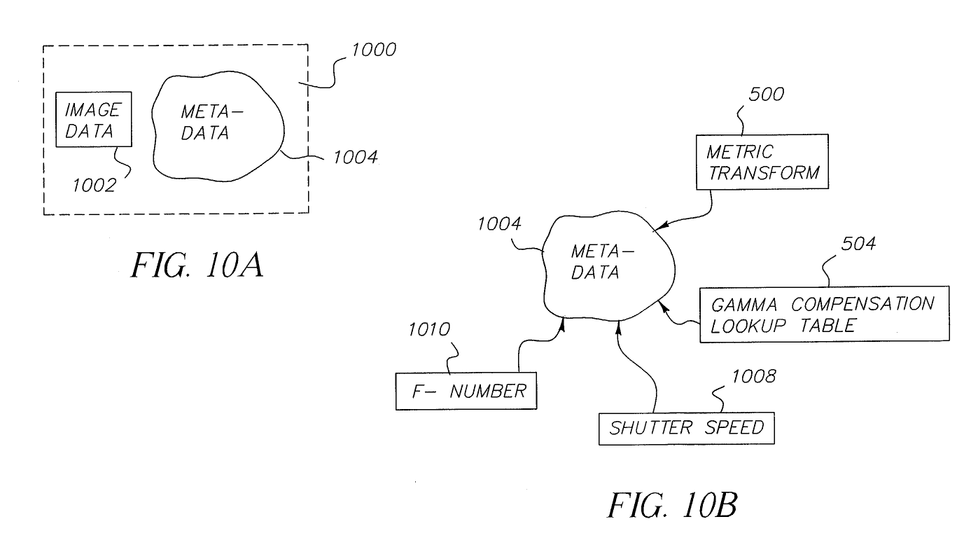

Referring finally to FIGS. 10A and 10B, at least one of the source digital image files 1000 may contain meta-data 1004 in addition to the image data 1002. Such meta-data 1004 could include the metric transform 500, a color transformation matrix, the gamma compensation lookup table 504, the shutter speed 1008 at which the image was captured, the f-number 1010 of the aperture when the image was captured, or any other information pertinent to the pedigree of the source digital image.

The invention has been described in detail with particular reference to certain preferred embodiments thereof, but it will be understood that variations and modifications can be effected within the spirit and scope of the invention.

PARTS LIST

| | |
|---|---|
| 10 | digital image processing system |
| 12 | digital image processing computer |
| 14 | network |
| 15 | image capture device |
| 16 | digital image store |
| 18 | high resolution color monitor |
| 20 | hard copy output printer |
| 21 | keyboard and trackball |
| 200 | provide source digital images step |
| 202 | modify source digital images step |
| 204 | combine adjusted source digital images step |
| 206 | composite digital image |
| 300 | source digital images |
| 302 | overlap regions |
| 400 | source digital image |
| 402 | metric transform |
| 404 | apply metric transform step |
| 406 | transformed source digital image |
| 500 | metric transform |
| 502 | matrix transform |
| 504 | gamma compensation lookup table |
| 600 | plot of relationship between pixel values of overlap region |
| 602 | second image values |
| 604 | first image values |
| 606 | identity line |
| 608 | actual line |
| 610 | constant offset |
| 700 | plot of relationship between pixel values of overlap region |
| 702 | second image values |
| 704 | first image values |
| 706 | identity line |
| 708 | actual line |
| 710 | linear offset |
| 800 | adjusted source digital images |
| 802 | pixel |
| 804 | overlap region |
| 806 | distances to image edges |
| 900 | provide source digital images step |
| 902 | modify source digital images step |
| 904 | combine adjusted source digital images step |
| 906 | composite digital image |
| 908 | transform pixel values step |
| 1000 | source digital image file |
| 1002 | image data |
| 1004 | meta-data |
| 1008 | shutter speed |
| 1010 | f-number |

What is claimed is:

1. A method for producing a composite digital image, comprising the steps of:
a) providing a plurality of partially overlapping source digital images having pixel values that are linearly or logarithmically related to scene intensity;
b) modifying the source digital images by applying linear exposure transform(s) to one or more of the source digital images to produce adjusted source digital images having pixel values that closely match in an overlapping region; and
c) combining the adjusted source digital images to form a composite digital image.

2. The method claimed in claim 1, wherein the step of providing source digital images further comprises the step of applying a metric transform to a source digital image such that the pixel values of the transformed source digital image are linearly or logarithmically related to scene intensity.

3. The method claimed in claim 2, wherein the metric transform is a scene independent transform.

4. The method of claim 1, wherein the combining step includes calculating a weighted average of the pixel values in the overlapping region.

5. The method of claim 1, further comprising the step of transforming the pixel values of the composite digital image to an output device compatible color space.

6. The method of claim 2, wherein the metric transform includes a color transformation matrix.

7. The method of claim 2, wherein the metric transform includes a lookup table.

8. The method of claim 2, wherein the metric transform is included as meta-data with the corresponding source digital image.

10. The method of claim 1, wherein the linear exposure transform is a function of the shutter speed used to capture the source digital image, and the shutter speed is included as meta-data with the corresponding source digital image.

11. The method of claim 1, wherein the linear exposure transform is a function of the f-number used to capture the source digital image and the f-number is included as meta-data with the corresponding source digital image.

12. A system for producing a composite digital image, comprising:
a) a plurality of partially overlapping source digital images having pixel values that are linearly or logarithmically related to scene intensity;
b) means for modifying the source digital images by applying linear exposure transform(s) to one or more of the source digital images to produce adjusted source digital images having pixel values that closely match in an overlapping region; and
c) means for combining the adjusted source digital images to form a composite digital image.

13. A computer program product for performing the method of claim 1.
